(19) United States
(12) Patent Application Publication
(10) Pub. No.: US 2007/0264887 A1
(43) Pub. Date: Nov. 15, 2007

(54) Connector system for high power applications

(76) Inventors: Richard W. Petersen, Belleville, MI (US); Bhupinder Rangi, Windsor (CA); Wolfgang Langoff, Leonberg (DE)

Correspondence Address: BLANK ROME LLP, 600 NEW HAMPSHIRE AVENUE, N.W., WASHINGTON, DC, 20037, US

(21) Appl. No.: 11/707,161

(22) Filed: Feb. 16, 2007

Related U.S. Application Data
(60) Provisional application No. 60/774,209, filed on Feb. 17, 2006.

(51) Int. Cl. H01R 9/24

(52) U.S. Cl. 439/886

(57) ABSTRACT

A connector system includes a first mating connector integrated with a housing for an automotive component and a second mating connector configured to engage the first mating connector. The connector further includes a shield adapted to cover the first and second mating connectors and provide a grounding path between the first and second mating connectors and the housing.

### CROSS-REFERENCE TO RELATED APPLICATIONS

This application claims benefit of U.S. Provisional Patent Application No. 60/774,209, filed on Feb. 17, 2006. The full disclosure of this provisional application is incorporated herein by reference.

### FIELD OF THE INVENTION

The present invention relates to a connector system for high power applications. More specifically, the connector system includes integrated mating connectors, which facilitate assembly, and seal and grounding members for protecting the connector system.

### DESCRIPTION OF RELATED ART

In automotive engines, the production and channeling of power is important to the overall function of the automobile. The power supplied to an automobile's transmission, as well as other components of the automobile, must be provided through a connection to a power source in the vehicle. This connection must be maintained during the operation of the vehicle and in the particular environment where the engine is housed. The connection must also be easy to make during assembly of the engine and should not require many steps to complete assembly.

Conventional connector systems for high power applications, such as for automobiles, often fail to provide adequate protection from the environment, such as automotive fluids, and fail to provide adequate shielding for protection against electromagnetic interference (EMI). Moreover, conventional connector systems used in automobiles are often difficult to assemble, thereby increasing assembly time of the automotive components of the vehicle.

Many of these concerns are also addressed in U.S. Pat. No. 5,692,909, issued to Steven A. Gadzinski, where an electrical connector assembly for an automatic transmission includes electrical conductors which are positioned by the cooperation of mounting protrusions extending from an insulating frame and engaging an oil pan associated with the transmission housing. The electrical conductors contained within the electrical connector assembly housing are electrically isolated from one another, securely positioned to prevent electrical interference with one another, and relatively easily removed facilitating replacement of components. While at least some of the above concerns are addressed in that patent, the connector assembly still does not provide adequate electromagnetic interference protection and still requires much assembly time. There is a need to simplify the connection to allow for improvements in assembly time and fewer parts that must be supplied for manufacture.

Thus, there is a need in the prior art to have systems and methods which avoid the need to accommodate the limitations discussed above. There is also a need for methods and systems that simplify and provide cost savings over the prior art systems for electrical connections.

### SUMMARY OF THE INVENTION

It is thus an object of the present invention to provide protection to an electrical connector system from environmental factors, such as automotive fluids. Another object of the present invention is to provide adequate shielding for protection against EMI and to simplify assembly, thereby decreasing assembly time of the automotive components of the vehicle.

To achieve the above and other objects, the present invention is directed to a connector system which comprises a first mating connector integrated with a housing for an automotive component and a second mating connector configured to engage the first mating connector. The connector further comprises a shield adapted to cover the first and second mating connectors and provide a grounding path between the first and second mating connectors and the housing.

Preferably, the connector system may be configured where one of the first and second mating connectors includes a pin and another of the first and second mating connectors includes a socket. The pin may be integrally formed with a lead frame that is in electrical contact with a contact for the automotive component, where the pin and the lead frame may be formed from a copper material. The connector system may include multiple pins and lead frames, with dielectric layers separating the multiple lead frames.

Also, the connector system may include a first seal member disposed between the first and second connectors and a second seal member disposed between the shield and the housing. At least one of the first and second seal members may be formed from a silicon rubber material. The connector system may also include a first grounding member electrically connecting one of said first and second mating connectors to the shield and a second grounding member electrically connection the shield to the housing.

In addition, the first mating connector may be integrated with a housing for a vehicle transmission, where the first mating connector is configured to be received in a recess in a wall of a housing of the vehicle transmission. The first mating connector may be electrically connected to a bus bar of a motor, where the first mating connector may be bolted or welded to a bus bar of a motor. The shield of the connector system may be formed from one of a metal and a metalized plastic material.

Also, the connector system may have a second mating connector that is electrically connected to a cable that passes through the shield and is electrically connected to another automotive component. The section of the cable and the shield where the cable passes through the shield may be sealed, where that sealing may be effected by overmolding using cylindrical metallic components.

Additionally, the present invention is also directed to a connector system comprising a first mating connector integrated with a housing for an automotive component, a second mating connector configured to engage the first mating connector and a shield adapted to cover the first and second mating connectors and provide a grounding path between the first and second mating connectors and the housing, the second mating connector being integrated with the shield.

### BRIEF DESCRIPTION OF THE DRAWINGS

FIG. 1 is a top perspective view of the connector system according to the present invention;

FIG. 2 is a top plan view of the connector system illustrated in FIG. 1;

FIG. 3 is another perspective view of the connector system illustrated in FIG. 1;

FIG. 4 is a top perspective view of the connector system illustrated in FIG. 1; showing the system with a cover removed and the engagement of first and second mating connectors;

FIG. 5 is a top perspective view of the connector system similar to FIG. 4, showing the system with the cover and a housing removed and the engagement of the mating connectors;

FIG. 6 is a top perspective view the connector system illustrated in FIG. 1, showing one of the mating connectors connected to two bus bars;

FIG. 7 is a top plan view of the connector system illustrated in FIG. 1, showing the system with the cover and one of the mating connectors removed; and

FIG. 8 is a perspective view of a grounding member of the connector system illustrated in FIG. 1.

### DETAILED DESCRIPTION OF THE PREFERRED EMBODIMENT

A preferred embodiment of the present invention will be set forth in detail with reference to the drawings, in which like reference numerals refer to like elements or operational steps throughout.

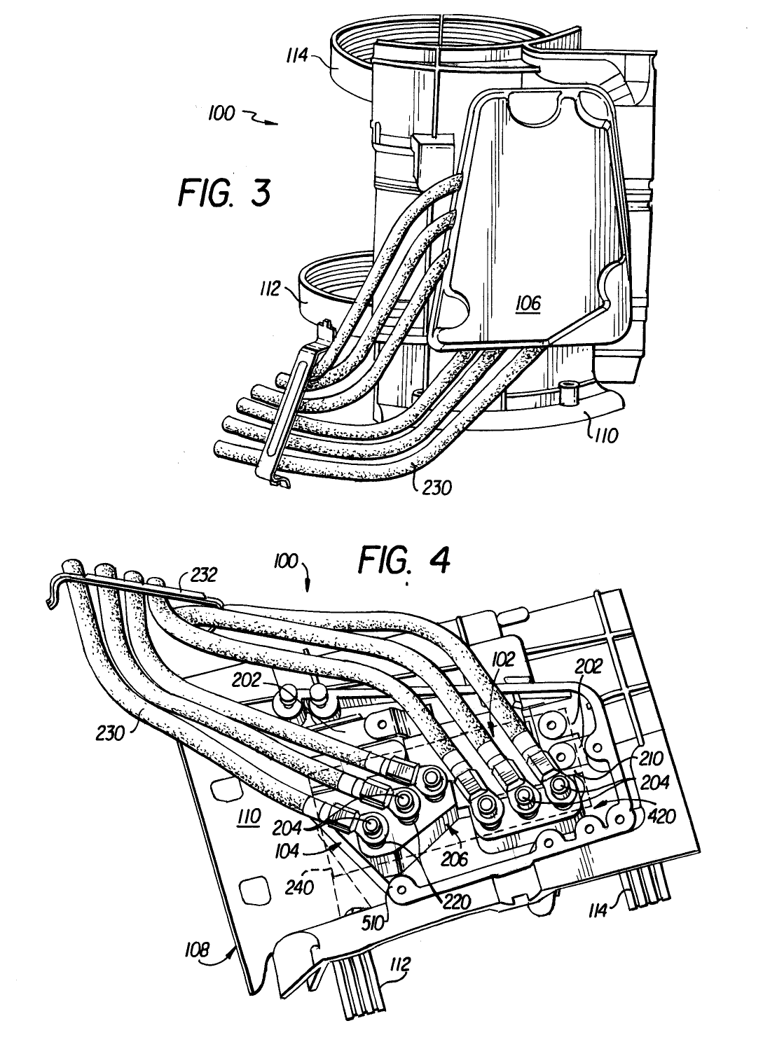

Referring to FIGS. 1-8, a connector system 100 in accordance with the present invention is preferably used in high power applications and generally includes first and second mating connectors 102 and 104, as shown in FIG. 4, and an associated shield 106, as shown in FIG. 1. The connector system 100 may be incorporated into an automotive component, such as a vehicle transmission 108, for example, to electrically connect one or more electric motors (not shown) to an electronic control unit (not shown) of the vehicle's engine.

The connector system may be used with other components, such as a battery, a distribution center, electronic power steering, electronic air conditioning, and the like. The connector system protects the connection area between the mating connectors from its surrounding environment, such as transmission fluid, and provides appropriate shielding to protect against EMI.

The first mating connector 102 may be integrated with the housing 110 of the transmission 108, as seen in FIG. 4, thereby improving assembly time of the transmission and vehicle. Specifically, the first mating connector 102 may be received in a recess 420 (FIG. 4) in the wall of the transmission housing 110. As seen in FIGS. 1-3, the transmission housing 110 supports first and second bus bars 112 and 114 of first and second electric motors (not shown).

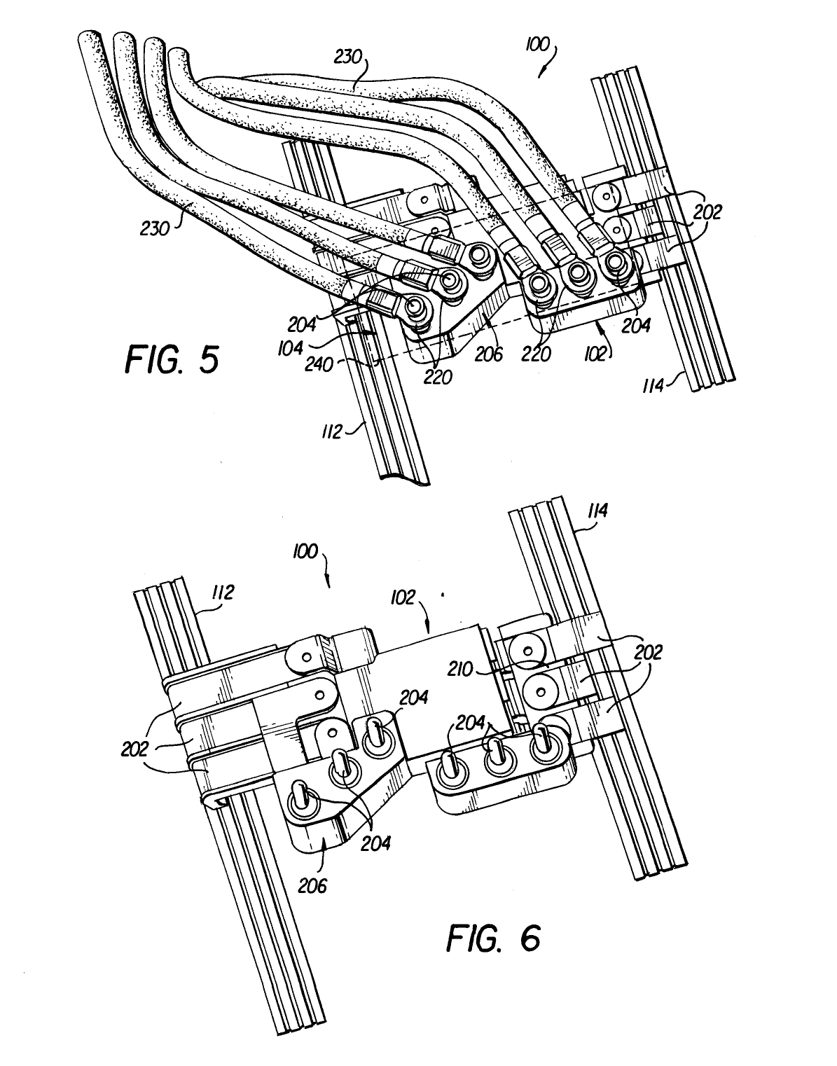

As seen in FIGS. 4-7, the first mating connector 102 includes a plurality of lead frames 202, best seen in FIG. 5, formed of metal, such as copper, that connect to terminals, such as pins 204, of the first mating connector 102. Each pin 204 may be connected to a respective lead frame 202 in any known manner, such as by press-fitting, welding, or the like.

Alternatively, the pins 204 may be integrally formed with each lead frame 202, such as by stamping. A connector body 206 supports the pins 204 and lead frames 202. A dielectric layer 210 is disposed between each lead frame 202 and is connected to the bus bars 112 and 114. The connector body 206 may be overmolded, i.e. the lead frames 202 and pins 204 are encapsulated with a dielectric material, such as plastic. The individual lead frames 202 may be formed together as one unit.

Bus bars 112 and 114 are electrically connected to the first mating connector 102 and pins 204 via lead frames 202. For example, the bus bars 112 and 114 may be connected to the lead frames 202 by bolting, welding, or the like. The first mating connector 102 sits in the recess 420 of the transmission housing 110, with either the lead frames 202 or the bus bars 112 and 114 extending through openings or slots in the wall of the transmission housing 110, at the sides of the recess 420, so that the lead frames 202 and bus bars 112 and 114 meet to form a connection. That arrangement integrates the first mating connector 102 with the transmission housing 110.

The second mating connector 104 includes a plurality of terminals, such as sockets 220, that terminate the ends of a plurality of cables 230 for connection with the first mating connector 102. Each cable 230 may include a conductor, an inner insulative layer, a foil layer, a metallic braided mesh, such as aluminum, and an outer insulative layer. The inner and outer insulative layers may be formed of a silicon material to meet temperature and flexibility requirements for a vehicle transmission. Although a plurality of individual cables 230 are shown, the cables may be formed as one cable, i.e. a plurality of conductors jacketed together with the inner insulative layer, the foil layer, the mesh, and the outer insulative layer. Stabilizing cable brackets with dampeners 232 may be provided for the cables 230. As seen in FIGS. 4 and 5, each socket 220 terminates the ends of cables 230 via a conventional crimping operation. Each socket 220 connects to a respective pin 204 of the first mating connector 102.

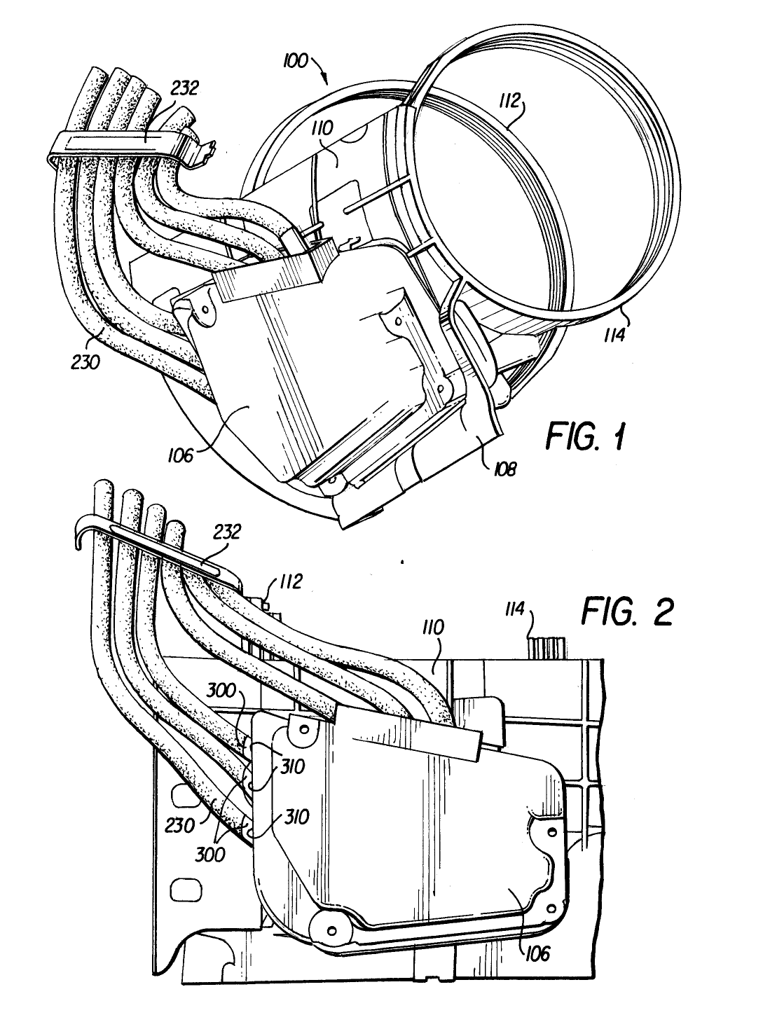

The second mating connector 104 may include a connector body 240 (FIGS. 4 and 5) that supports the sockets 220 and the ends of cables 230. Preferably, the connector body 240 is overmolded using a dielectric material so that it encapsulates sockets 220. Cables 230 may be sealed with respect to the connector body 240 during the overmolding process using cylindrical metallic components 300 (FIG. 2). The cylindrical components may be coined or spun to create a sealing area to prevent transmission fluid from exiting the sealed connector system 100.

As seen in FIGS. 1-3, the shield or cover 106 covers the assembled first and second mating connectors 102 and 104. The cover 106 is formed of a conductive material, such as metal or metalized plastic, to provide shielding for the connector system 100. Any known attachment may be used to mount the cover 106 to the wall of the transmission housing 110, such as bolts. A plurality of openings or cutouts 310 (FIG. 2) are provided in the cover 106 corresponding to each cable 230. The openings 310 may be sealed by overmolding. To facilitate assembly and sealing, the second mating connector 104 may be mounted to the cover 106 by mounting its connector body 240 with the inside of the cover 106 by overmolding, bolting, or the like.

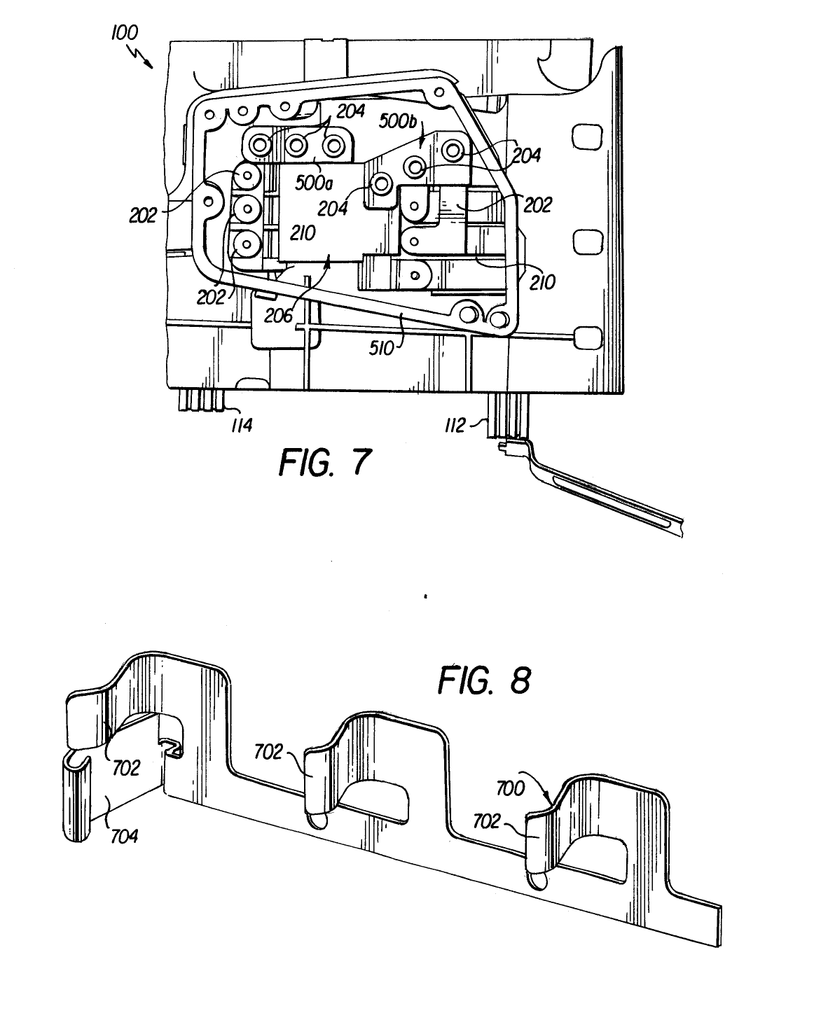

Due to the environment of the connector system 100, the connection area between the first and second mating connectors 102 and 104 should be protected and sealed. To protect the connection area, inner seal members 500a and 500b and an outer seal member 510 are provided, as seen in FIG. 7. The seal members are formed of any compliant material, such as silicon rubber. The inner seal members 500a and 500b are compressed between the connector bodies 206 and 240 of the first and second mating connectors, respectively, at the connection of the pins 204 and sockets 220. The outer seal member 510 is disposed along an outer footprint on the transmission housing 110 where the cover 106 mounts to the housing 110, as seen in FIG. 7.

To shield the connector system 100, grounding paths are defined between the first and second mating connectors 102 and 104 and the cover 106, and between the cover 106 and the transmission housing 110. A grounding member, such as clamp 700 (FIG. 8), includes resilient arms 702 that engage the sockets 220 of the second mating connector 104 of the cables 230 and a resilient extension 704 that engages the cover 106 to define a grounding path. Electric conductivity between the first mating connector 104 and the cover 106 may also be achieved by plating, spraying, deposition, or similar process. The grounding path between the cover 106 and the transmission housing 110 may be provided by holes (not shown) disposed in the outer seal member 510, the bolts used to mount the cover 106 to the housing 110, spring arms extending from the cover engaging the wall of the transmission housing 110, a conductive seal, or the like.

While a particular embodiment has been chosen to illustrate the invention, it will be understood by those skilled in the art that various changes and modifications can be made therein without departing from the scope of the invention as defined in the appended claims. For example, the pins 204 of the first mating connector 102 and the sockets 220 of the second mating connector 104 may be reversed so that the first mating connector includes sockets and the second mating connector includes pins. Also, only a single pin and socket are required for electrical connection between the first and second mating connectors 102 and 104. Although two bus bars 112 and 114 are illustrated which are part of two electric motors (not shown), the connector system 100 may be used with a single bus bar and electric motor. Also, although three cables 230 are illustrated that correspond to each electric motor, such as 3 phase AC electric motors, a single cable may be used.

What is claimed is:

1. A connector system, comprising:
a first mating connector integrated with a housing for an automotive component;
a second mating connector configured to engage the first mating connector; and
a shield adapted to cover the first and second mating connectors and provide a grounding path between the first and second mating connectors and the housing.

2. A connector system according to claim 1, wherein one of the first and second mating connectors includes a pin and another of the first and second mating connectors includes a socket.

3. A connector system according to claim 2, wherein the pin is integrally formed with a lead frame that is in electrical contact with a contact for the automotive component.

4. A connector system according to claim 3, wherein the pin and the lead frame are formed from a copper material.

5. A connector system according to claim 3, wherein one of the first and second mating connectors includes multiple pins and lead frames, with dielectric layers separating the multiple lead frames.

6. A connector system according to claim 1, further comprising a first seal member disposed between the first and second connectors and a second seal member disposed between the shield and the housing.

7. A connector system according to claim 6, wherein at least one of the first and second seal members is formed from a silicon rubber material.

8. A connector system according to claim 1, further comprising
a first grounding member electrically connecting one of said first and second mating connectors to the shield; and
a second grounding member electrically connecting the shield to the housing.

9. A connector system according to claim 1, wherein the housing is for a vehicle transmission.

10. A connector system according to claim 9, wherein the first mating connector is configured to be received in a recess in a wall of the housing of the vehicle transmission.

11. A connector system according to claim 9, wherein the first mating connector is electrically connected to a bus bar of a motor.

12. A connector system according to claim 11, wherein the first mating connector is bolted or welded to the bus bar of the motor.

13. A connector system according to claim 1, wherein the second mating connector is electrically connected to a cable that passes through the shield and is electrically connected to another automotive component.

14. A connector system according to claim 13, wherein a section of the cable and the shield where the cable passes through the shield is sealed.

15. A connector system according to claim 14, wherein the section of the cable and the shield are sealed by overmolding using cylindrical metallic components.

16. A connector system according to claim 1, wherein the shield is formed from one of a metal and a metalized plastic material.

17. A connector system, comprising:
a first mating connector integrated with a housing for an automotive component;
a second mating connector configured to engage the first mating connector; and
a shield adapted to cover the first and second mating connectors and provide a grounding path between the first and second mating connectors and the housing, the second mating connector being mounted to the shield so that it is integrated with the shield.

18. A connector system according to claim 17, wherein one of the first and second mating connectors includes a pin and another of the first and second mating connectors includes a socket.

19. A connector system according to claim 18, wherein the pin is integrally formed with a lead frame that is in electrical contact with a contact for the automotive component.

20. A connector system according to claim 19, wherein the pin and the lead frame are formed from a copper material.

21. A connector system according to claim 19, wherein one of the first and second mating connectors includes multiple pins and lead frames, with dielectric layers separating the multiple lead frames.

22. A connector system according to claim 17, further comprising a first seal member disposed between the first and second connectors and a second seal member disposed between the shield and the housing.

23. A connector system according to claim 22, wherein at least one of the first and second seal members is formed from a silicon rubber material.

24. A connector system according to claim 17, further comprising
a first grounding member electrically connecting one of said first and second mating connectors to the shield; and
a second grounding member electrically connecting the shield to the housing.

25. A connector system according to claim 17, wherein the housing is for a vehicle transmission.

26. A connector system according to claim 25, wherein the first mating connector is configured to be received in a recess in a wall of the housing of the vehicle transmission.

27. A connector system according to claim 25, wherein the first mating connector is electrically connected to a bus bar of a motor.

28. A connector system according to claim 27, wherein the first mating connector is bolted or welded to the bus bar of the motor.

29. A connector system according to claim 17, wherein the second mating connector is electrically connected to a cable that passes through the shield and is electrically connected to another automotive component.

30. A connector system according to claim 29, wherein a section of the cable and the shield where the cable passes through the shield is sealed.

31. A connector system according to claim 30, wherein the section of the cable and the shield are sealed by overmolding using cylindrical metallic components.

32. A connector system according to claim 17, wherein the shield is formed from one of a metal and a metalized plastic material.
